(19) United States
(12) Patent Application Publication
(10) Pub. No.: US 2026/0073779 A1
(43) Pub. Date: Mar. 12, 2026

(54) PERSONALIZED ESCAPE ASSISTANCE ARRANGEMENT AND PERSONALIZED ESCAPE ASSISTANCE METHOD

(71) Applicant: Dräger Safety AG & Co. KGaA, Lübeck (DE)

(72) Inventors: Rainer Buchner, Lübeck (DE); Steffen Rittemann, Lübeck (DE); Rene Krüger, Lübeck (DE)

(21) Appl. No.: 19/314,263

(22) Filed: Aug. 29, 2025

(30) Foreign Application Priority Data
Sep. 6, 2024 (DE) 102024125572.2

(51) Int. Cl. G08B 7/06

(52) U.S. Cl. CPC G08B 7/066; G08B 7/062

(57) ABSTRACT

The escape assistance arrangement and the escape assistance method guide a user to a safe target position if an alarm situation has occurred in a spatial area and an alarm message has therefore been sent. The user carries an escape assistance device with a vital parameter sensor, a geoposition sensor and an output unit. A navigation unit calculates an escape route for the user, wherein the escape route leads from the current geoposition of the user to the safe target position. The navigation unit generates an escape route description for this escape route. For this purpose, it classifies the user's current state depending on a vital parameter and generates the escape route description depending on the classified current state. The output unit outputs the escape route description.

### CROSS-REFERENCE TO RELATED APPLICATIONS

This application claims the priority of German Patent Application No. 102024125572.2, filed on Sep. 6, 2024, and titled “PERSONALIZED ESCAPE ASSISTANCE ARRANGEMENT AND PERSONALIZED ESCAPE ASSISTANCE METHOD”, which is hereby incorporated by reference in its entirety for all non-limiting purposes.

### TECHNICAL FIELD

This disclosure relates to an escape assistance arrangement that is configured, in the event of an alarm situation, to calculate and output an escape route for a user of an escape assistance device of the escape assistance arrangement. Furthermore, this disclosure relates to an escape assistance method, which is performed using such an escape assistance arrangement.

### BACKGROUND

An alarm situation occurs in a spatial area, for example, if a gas warning device has detected an impermissible (inadmissible) concentration of a target gas in the spatial area. The target gas is, for example, a gas that is harmful to humans, or oxygen or an anesthetic. An alarm situation also occurs if fire or smoke has been detected or if an operator has activated an alarm activation unit. In this case, all humans in the spatial area must immediately leave the spatial area and reach a safe target position. One problem is the possibility that at least some humans are unfamiliar with the spatial area and therefore do not know how to reach a safe target position. This problem occurs in particular if the spatial area is accessible to the public. Another problem that can occur is that a human in the spatial area is in a panic state.

### SUMMARY

This disclosure is based on the object of providing an escape assistance arrangement and an escape assistance method that make it possible in a more reliable manner than known escape assistance arrangements and escape assistance methods for a human to leave a spatial area in which an alarm situation has occurred.

The object is achieved by an escape assistance arrangement having the features set forth herein. Advantageous embodiments are specified in the dependent claims. Advantageous embodiments of the escape assistance arrangement according to this disclosure are, as far as appropriate, also advantageous embodiments of the escape assistance method according to this disclosure, and vice versa.

The escape assistance arrangement and the escape assistance method guide a user to a safe target position if an alarm situation has occurred in a spatial area and an alarm message has therefore been sent. The user carries an escape assistance device with a vital parameter sensor, a geoposition sensor, and an output unit. A navigation unit calculates an escape route for the user, wherein the escape route leads from the current geoposition of the user to the safe target position. The navigation unit generates an escape route description for this escape route. For this purpose, it classifies the user's current state depending on a vital parameter and generates the escape route description depending on the classified user's current state. The output unit outputs the escape route description.

### BRIEF DESCRIPTION OF THE DRAWINGS

In the drawings,

FIG. 1 shows an example arrangement of a plurality of sensors and output units in a spatial area to be monitored;

FIG. 2 shows, by way of example, a monitored spatial area and an escape route from the spatial area to a safe target position;

FIG. 3 shows an example of escape assistance device with a local navigation unit and external sensors;

FIG. 4 shows an example embodiment with a central navigation unit and two escape assistance devices and two escape route descriptions for the same escape route;

FIG. 5 shows a further example embodiment of an escape route description.

### DETAILED DESCRIPTION

The terms “spatial area,” “alarm situation”, and “safe target position” are used below. A spatial area may be any area in which humans are or can be present, in particular publicly accessible places and facilities, buildings, vehicles, and industrial plants. An alarm situation in the spatial area exists if an event has occurred there that is dangerous for humans, for example a fire or smoke or the release of a gas that is harmful to humans, or even a lack of oxygen. An alarm situation also exists if there is a threat of an explosion or if an operator has activated an alarm activation unit and thereby has broadcasted the request that the spatial area has to be evacuated. A safe target position is a position where humans can remain even if the alarm situation has occurred. The safe target position can be in the spatial area or outside the spatial area. In particular, the safe target position can be a meeting point outside the spatial area or a protective chamber or other shelter.

The escape assistance arrangement according to this disclosure comprises an escape assistance device. The escape assistance device can be carried by a human with him/her. In particular, the escape assistance device can be fastened to the user's clothing and preferably removed again. The escape assistance device is configured such that the human can carry the escape assistance device with him/her while the human is in the spatial area. In the following, this human is referred to as the “user” of the escape assistance device. Of course, it is possible that different users use the same escape assistance device one after the other. Preferably, the escape assistance arrangement according to this disclosure comprises a plurality of escape assistance devices, which can each be used by one user. Several escape assistance devices can be used in a manner overlapping in time.

A vital parameter sensor of the escape assistance device is configured to measure a vital parameter of the user. Preferably, the vital parameter sensor measures the vital parameter several times, for example with a fixed sampling frequency. Examples of such vital parameters are respiratory rate, heart rate, blood pressure, and oxygen saturation of the blood. The vital parameter sensor is configured to generate a signal, wherein the signal comprises information about the measured vital parameter, more precisely: about the measured value of the vital parameter or the sequence of the measured values. Optionally, the escape assistance device comprises a plurality of vital parameter sensors, which are each configured to measure a respective vital parameter.

A geoposition sensor of the escape assistance device is configured to measure its own current geoposition (geographical position). Given that the user carries the escape assistance device and thus the geoposition sensor with him/her, the geoposition of the geoposition sensor matches the geoposition of the user with sufficient accuracy. Preferably, the geoposition sensor measures its own geoposition several times, for example with a fixed sampling frequency. The geoposition sensor is configured to generate and output a signal, wherein the signal comprises information about the measured own geoposition.

Note: The wording is used that a sensor is configured to measure a physical variable, in particular a vital parameter or a geoposition. This wording means that the sensor is configured to directly measure the physical variable or at least one other variable that correlates with the variable to be measured. The or another measured variable or the combination of the other measured variables together are therefore an indicator for the physical variable to be measured. The measurement provides at least one value for the physical variable sought.

An output unit of the escape assistance device is configured to output information in a form perceptible to a human, in particular visually, acoustically, and/or haptically (via vibrations). Optionally, the escape assistance device comprises a plurality of output units in order to output the same information in different ways that are all perceptible to a human. Optionally, the escape assistance device also comprises an input unit and is configured to capture and evaluate a user input on this input unit.

If the escape assistance arrangement comprises a plurality of escape assistance devices, preferably each escape assistance device has at least one vital parameter sensor, one geoposition sensor, at least one output unit, and optionally one input unit.

The escape assistance arrangement further comprises a signal-processing navigation unit. The navigation unit can be spatially remote from the or each escape assistance device and can in particular be a component of a stationary computer or a computer on board of a vehicle. In the case of a navigation unit arranged spatially remote, a bidirectional data connection is established at least temporarily between the navigation unit and the escape assistance device; in the case of a plurality of escape assistance devices, a respective bidirectional data connection is established with each escape assistance device. The navigation unit can also be a component of the escape assistance device. It is also possible that a first component of the navigation unit belongs to the escape assistance device, and a second component is spatially separated.

Preferably the navigation unit comprises a processor and a memory unit on which a program is stored. The program can be executed by the processor. In the following, the term is used that the navigation unit is configured to perform specified steps. This means the following: While the program is executed by the processor, the program causes the navigation unit to perform the corresponding steps.

In the case of a plurality of escape assistance devices, each escape assistance device can comprise its own navigation unit. It is also possible that the navigation unit is a component of a first escape assistance device of the escape assistance arrangement and that the or each further escape assistance device is in a bidirectional data connection with the navigation unit of the first escape assistance device.

The navigation unit is configured to receive and process an alarm message. The received alarm message contains information that an alarm situation occurs in the spatial area. Of course, it is possible that the navigation unit receives a plurality of alarm messages in succession. The alarm message may have been generated and sent in response to a corresponding sensor having detected the alarm situation. The sensor can be spatially remote from the navigation unit or be a component of the navigation unit. It is also possible that an operator in a monitoring unit has triggered the step of sending the alarm message.

The navigation unit has, at least temporarily, read access to a given area data memory. The area data memory can be a component of the navigation unit or can be spatially remote from the navigation unit. On the one hand, the area data memory stores a computer-evaluable description of the spatial area. In particular, this description comprises a floor plan or a map. Optionally, the description also comprises an identifier of bottlenecks in the spatial area. On the other hand, a computer-evaluable identifier of a safe target position is stored on the area data memory. Optionally, the respective identifiers of a plurality of safe target positions are stored.

The escape assistance method according to this disclosure is performed using an escape assistance arrangement according to this disclosure. The escape assistance method is performed while the user is in the spatial area and is carrying the escape assistance device with him/her. In one situation, the escape assistance method is performed while a plurality of users is in the spatial area at the same time and each user is carrying an escape assistance device with him/her.

The escape assistance arrangement according to this disclosure is configured to perform the following steps in response to the receipt of the alarm message, and the following steps are performed according to the escape assistance method according to this disclosure in response to the navigation unit having received the alarm message:

The navigation unit calculates an escape route for the user. This escape route starts at the measured current geoposition of the geoposition sensor. The escape route leads to the safe target position or, in the case of a plurality of safe target positions, to one of them. In order to calculate the escape route, the navigation unit processes the signal of the geoposition sensor, the stored description of the spatial area, and the stored identifier of the safe target position.

In one embodiment, the navigation unit uses the most recently measured geoposition in order to calculate the escape route. In one embodiment, the step of the navigation unit receiving the alarm message triggers the step of the geoposition sensor measuring its own current geoposition.

Optionally, identifiers of a plurality of safe target positions are stored. Optionally, the navigation unit also evaluates the alarm message in order to calculate the escape route. The navigation unit decides, depending on the alarm message, to which safe target position the escape route to be calculated should lead. For example, depending on the alarm message, the navigation unit selects a safe target position within the spatial area or a safe target position outside the spatial area.

It is possible that, at the time point at which the alarm message is received, a plurality of users is in the spatial area and each user is carrying an escape assistance device with him/her. In this situation, the navigation unit calculates for each user a respective escape route.

The navigation unit generates an escape route description. The generated escape route description describes the calculated escape route in a form perceptible to a human. In case of a plurality of users, the navigation unit generates for each user a respective escape route description.

The navigation unit actuates the output unit. The actuated output unit outputs the generated escape route description. In the case of a plurality of escape assistance devices, each output unit outputs the corresponding escape route description.

The step that the navigation unit actuates the output unit can comprise the following step: the navigation unit transmits the generated escape route description to the escape assistance device and activates the escape assistance device. The activated escape assistance device activates the output unit.

An escape route is a route from a first geographical location, here the measured current geoposition of the user, to a second geographical location, here the safe target position. An escape route description is a description of the escape route, wherein the escape route description describes the escape route to the user in such a way that the user knows how to reach the safe target position, the user knowing it without further aids, provided the user is currently able to understand and follow the escape route description.

According to this disclosure, the step of the navigation unit receiving the alarm message triggers the steps just described. It is also possible that user input additionally triggers the steps just described. In particular, this user input specifies that the user demands the escape assistance device to generate and output the description of an escape route from the spatial area.

According to this disclosure, the navigation unit is configured to generate at least two different possible escape route descriptions for the same calculated escape route. Preferably, it actually generates one escape route description. The actuated output unit actually outputs one of these possible escape route descriptions in order to describe the calculated escape route, namely the actually generated one. The possible escape route descriptions differ from one another in the manner in which a calculated escape route is displayed. For example, a first possible escape route description comprises a map of the spatial area and a path that is inserted into the map and describes the escape route. A second possible escape route description comprises a sequence of images, wherein each image shows a location in the spatial area, and wherein the sequence of the images defines the order in which a user must pass these locations to reach the safe target position along the escape route. A third possible escape route description comprises a sequence of textual descriptions, which are output visually and/or acoustically. A fourth possible escape route description comprises a sequence of direction indicators, optionally supplemented by a respective indication of the distance to be covered in this direction.

The escape assistance arrangement according to this disclosure is configured to automatically perform the following steps, and the escape assistance method according to this disclosure comprises the following steps to be executed automatically:
The navigation unit classifies the current state of the user. In order to classify the current state, the navigation unit processes the signal of the vital parameter sensor, optionally the signals of a plurality of vital parameter sensors, of the escape assistance device. The or each vital parameter sensor is part of the escape assistance device that the user carries with him/her.
In one embodiment, the navigation unit uses the most recently measured value of the vital parameter in order to classify the current state of the user. In another embodiment, the step of the navigation unit receiving the alarm message triggers the step of the vital parameter sensor measuring the vital parameter.
The navigation unit generates one of the at least two possible escape route descriptions as the escape route description that is actually output. In order to generate one of the possible escape route descriptions as the escape route description that is actually output, the navigation unit uses the classified current state of the user.

In one embodiment, the navigation unit initially classifies the current state of the user and then generates the escape route description depending on the classified state and causes the escape route description to be output. In another embodiment, the navigation unit generates at least two possible escape route descriptions and subsequently selects one of the generated possible escape route descriptions depending on the current user state and causes this escape route description to be output.

In certain embodiments, a plurality of presentation types is specified in order to generate an escape route description for a previously calculated escape route. For a given escape route, each presentation type leads to a different escape route description. Depending on the classified state of the user, the navigation unit selects a presentation type and uses the selected presentation type in order to generate the escape route description. In one implementation, a standard presentation type and at least one further presentation type are specified. The navigation unit uses the standard presentation type unless the classified current state of the user is outside a standard range, more precisely: the measured value of the or one vital parameter is outside a given value range.

According to this disclosure, the user carries the escape assistance device while the user is in the spatial area. This carried escape assistance device outputs the escape route description in a form perceptible to a human. Thanks to this embodiment, it is not necessary that a spatially remote device, for example a stationary display unit or a display unit of a stationary or moving vehicle or aircraft, gives instructions or information to the user. In particular in the case of darkness, smoke or lack of space, it is often difficult for a user to perceive information from a display unit that is spatially remote. Sometimes the energy supply is switched off in the case of an alarm situation. This disclosure further eliminates the need for a vehicle or aircraft to move along the escape route and thereby specify or indicate the escape route to the user. The user must then continuously keep the vehicle or aircraft in view in order to follow it. Rather, the output escape route description informs the user about the escape route.

According to this disclosure, a vital parameter of the user is measured by a vital parameter sensor, wherein the vital parameter sensor belongs to the escape assistance device that the user carries with him/her. Thanks to this feature, in many cases the vital parameter can be measured more reliably than with the following conceivable embodiment: A spatially remote sensor, in particular a camera, measures the vital parameter remotely. Some vital parameters can only be measured by a sensor that the user carries but not remotely.

According to this disclosure, the current geoposition of the user is measured by the geoposition sensor measuring its own geoposition. Given that the user carries the escape assistance device with the geoposition sensor, the user's geoposition matches the measured geoposition of the geoposition sensor with sufficient accuracy. Thanks to this embodiment, the geoposition in many cases is measured more reliably than if a spatially remote sensor were to measure the user's geoposition.

According to this disclosure, the navigation unit calculates an escape route that starts at the user's current geoposition. The output unit outputs the escape route description for this escape route. Thanks to these features, the risk that the user will not reach the safe target position is lower than with an embodiment in which only general information are output to the user and this general information neither depend on the user's current geoposition nor on the user's state.

According to this disclosure, the event that the navigation unit has received the alarm message triggers the steps of the navigation unit calculating the escape route and generating the escape route description and of the output unit outputting the escape route description. These features eliminate the need for a user to enter a user input in order to trigger these steps. However, it is possible that the escape assistance device comprises an input unit and a corresponding user input triggers these steps.

According to this disclosure, a distinction is made between an escape route and an escape route description for this escape route. An escape route is a set of data calculated by the navigation unit, for example a sequence of geopositions or a sequence of points in a specified two-dimensional or three-dimensional coordinate system. The escape route description can be displayed in a manner perceptible to a human, and the user can perceive and use the escape route description while the escape route description is output by the output unit. For the same escape route, there are at least two different possible (potential) escape route descriptions.

According to this disclosure, the navigation unit generates the escape route description depending on the classified current state of the user. The escape route description is thus adapted to the current state of the user. This feature reduces the risk that a user, due to his/her current state, will not understand and therefore cannot follow the output escape route description. This risk exists in particular if the user is in a panic state and is therefore currently unable to understand and use an escape route description with a map and a path in this map.

In many cases, the escape assistance arrangement according to this disclosure can automatically detect whether or not a user is in a panic state. In a first implementation, the navigation unit evaluates the signal of the vital parameter sensor as follows: A user in a panic state usually has a significantly higher heart rate and/or respiratory rate than a user who is not in a panic state. The navigation unit generates the escape route description depending on whether or not the measured vital parameter indicates that the user is in a panic state. An alternative or additional second implementation can be applied if a user has already covered part of a previously calculated escape route and may now be in a panic state. An indication that the user is now in a panic state is the following detection: The user moves in a zigzag pattern, although the escape route is not zigzag, or at least not as zigzag as the user's movement path. The navigation unit is configured to detect a zigzag movement path of the user, in particular based on the signal of the geoposition sensor.

This disclosure reduces the risk of the following undesirable event occurring: The escape assistance device outputs an escape route description. The user cannot follow the output escape route description and therefore also cannot follow the escape route because the user is in a panic state. On the other hand, a sufficiently detailed escape route description will in many cases be output to a user who has remained calm “has kept a clear head”.

This disclosure can be used in combination with an escape assistance device that has a selection unit, wherein, with the aid of the selection unit, a user can enter his/her current state or define which escape route description is to be generated and output for the calculated escape route. However, this disclosure eliminates the need for a user to use such a selection unit in order to obtain an escape route description suitable for the user or an escape route description that deviates from a standard description. A user in a panic state will often not be able to use such a selection unit correctly or to choose an escape route description that is currently understandable to the user.

According to this disclosure, the escape route description output depends on the determined current state of the user. This feature can be combined with an embodiment in which the user is registered in a user data memory and the escape route description is generated depending on stored information about the user. For example, a user's physical impairment is stored. The navigation unit captures the information which user is currently using the escape assistance device and uses the stored information about this user. For example, the navigation unit generates the escape route description such that the escape route description is adapted to a stored physical disability of the user. However, this disclosure eliminates the need to generate the escape route description depending on stored information about the user. Panic is usually a temporary state, whereas physical impairment is often permanent.

According to this disclosure, the navigation unit calculates the escape route for the user, wherein the escape route leads from the user's current geoposition to the safe target position. For this purpose, the navigation unit uses the description of the spatial area, the stored identifier of the safe target position, and the measured current geoposition. Optionally, the navigation unit also evaluates the alarm message in order to calculate the escape route, for example to select one of a plurality of given safe target positions. In one embodiment, the navigation unit additionally uses the information about the user just described, wherein the user is registered in a user data memory and the information about this user is stored on the data memory.

In one embodiment, the navigation unit calculates at least two candidates for an escape route from the current geoposition to the safe target position. Optionally, a plurality of safe target positions is given, and the navigation unit calculates at least one escape route candidate to a first safe target position and at least one escape route candidate to a second safe target position. The navigation unit rates (assesses) each escape route candidate. The rating takes into account, for example, the length of the escape route and/or the information on how many bottlenecks and obstacles are located on this escape route candidate, and/or the alarm message. Optionally, stored information about the user is also taken into account in the rating. The navigation unit selects an escape route candidate depending on the ratings and uses the selected escape route candidate as the calculated escape route, for which an escape route description is subsequently generated.

According to this disclosure, the navigation unit generates the escape route description depending on the measured classified state of the user. The embodiment described below often results in an escape route description that the user can understand and follow even if the user is in a panic state and/or is unfamiliar with the spatial area and therefore does not understand a map.

According to this example embodiment, an image set is stored on the area data memory, wherein the image set comprises a plurality of images. Each image shows a respective part of the spatial area. Each image is stored together with an identifier of a geoposition. The stored identifier indicates the geoposition that an image recording device, in particular a camera, had while generating the image. The images preferably show striking, i.e., easily recognizable, objects and/or other striking areas of the spatial area. Preferably, the images are generated in advance and are stored together with the geoposition identifiers in the area data memory. Preferably, the images together cover the entire spatial area or at least an area of the spatial area, wherein this area is accessible to humans, but the rest of the spatial area is not.

According to this embodiment, the navigation unit generates the escape route description as follows: The escape route has already been calculated. The generated escape route description comprises an image sequence, which is one image from the image set or a sequence, i.e., an order, with a plurality of images from the image set. Each image in this image sequence shows a part of the spatial area, wherein the calculated escape route leads past or through this spatial part. In other words, if a user moves along this escape route, the user sees the spatial part of the spatial area shown by the image. The order of the images in the image order corresponds to the order in which the shown spatial parts of the spatial area become visible one after the other while the user moves along the calculated escape route. In other words, the order of the images corresponds to the order of the spatial parts while moving along the escape route.

The embodiment described below takes into account the possibility that the current state of the user changes after the output unit has output the escape route description and while the user uses the output escape route description in order to reach the safe target position. For example, the user is in a panic state on the way to the safe target position. Or the user was in a panic state when the user received the alarm message, but he/she calmed down thereafter.

According to this embodiment, the navigation unit determines the current state of the user at least once again, preferably repeatedly, in particular with a fixed sampling frequency. For this purpose, it uses the signal of the vital parameter sensor. At least if a significantly different state of the user is detected during this renewed determination than when the alarm message was received, the following step is performed: The navigation unit generates an updated escape route description. In order to generate the updated escape route description, the navigation unit processes the user's state that it classified as a result of the renewed determination.

In one implementation, the updated escape route description refers to the originally calculated escape route. A below-described different implementation of the embodiment with the updated escape route description takes into account the possibility that the user significantly deviates from the calculated escape route on the way to the safe target position. For example, the user did not correctly understand the original escape route description or got lost. Or the original escape route can no longer be used and is blocked.

The often undesirable and sometimes inevitable result of the user having deviated from the escape route often means that the originally generated escape route description is no longer suitable for guiding the user to the safe target position. In addition, in some cases, the undesirable event causes the user to panic.

According to the different implementation, the navigation unit determines the current geoposition of the geoposition sensor and thus that of the user at least once again, preferably repeatedly, in particular with a fixed sampling frequency. Preferably, the navigation unit compares the newly determined current geoposition with the initially calculated escape route.

The steps described below are triggered at least if the generally undesirable result has been detected that the newly determined current geoposition is more than a specified position barrier remote from the calculated escape route. It is also possible that these steps are triggered at least once while the user is on the way to the safe target position, for example after a specified period of time has elapsed, or in response to a corresponding user input. The steps triggered are the following:
The navigation unit calculates an updated escape route. This updated escape route starts at the newly determined current geoposition and also leads to the or one safe target position. The updated escape route may differ from the originally (initially) calculated escape route, namely if the newly measured geoposition is not on the originally calculated escape route.
The navigation unit generates the updated escape route description as follows: The updated escape route description describes the updated escape route and depends on the user's state.

To generate the updated escape route description, the navigation unit thus uses, on the one hand, the newly determined current state and, on the other hand, the newly determined current geoposition of the user.

In one embodiment, the detection that the newly determined current geoposition is considerably remote from the initially calculated escape route additionally triggers the following step: The navigation unit causes a message to be output. This message comprises the information that the user has deviated from the original escape route. In one embodiment, this message is output on a display unit of a spatially remote receiver, for example in an operation center. In one embodiment, this message is output on the output unit of the escape assistance device. In one implementation, the navigation unit only causes the message to be output on the output unit of the escape assistance device if the navigation unit has previously detected that the user is not in a panic state. This is because a user who is already in a panic state may be even more panicked by this message.

According to this disclosure, the navigation unit calculates an escape route and generates an escape route description for this escape route. The embodiment described below reduces the risk that the calculated escape route is dangerous for a human due to an alarm situation and is therefore impassable.

According to this embodiment, the navigation unit is configured to receive and process an alarm situation signal. The alarm situation signal comprises information about an alarm situation in the spatial area. Furthermore, the alarm situation signal comprises information about a geoposition at which this alarm situation occurs. For example, the alarm situation was detected by a sensor, and the geoposition in the alarm situation signal is the geoposition of this sensor or the geoposition of a detection range of this sensor. The alarm situation is, for example, an impermissible target gas concentration or the occurrence of flames or smoke or heat or a rising water level. The alarm situation signal can come directly from the sensor that detected the alarm situation, or from a central alarm unit that receives and processes sensor signals.

According to this disclosure, the navigation unit processes the current geoposition of the geoposition sensor, the description of the spatial area, and the identifier of the safe target position in order to calculate the escape route. According to the embodiment just described, the navigation unit additionally processes the received alarm situation signal. In one implementation, the navigation unit ensures that the escape route is at a sufficiently large distance from the geoposition of the received alarm situation signal.

In one implementation, the description of the spatial area comprises the geoposition of an object. Thanks to the object, the event that caused the alarm situation does not affect the escape route. Such an object is, for example, a fluid-tight door or a fluid-tight closure that keeps out harmful gases, or a fire-resistant or heat-resistant door or wall. If such an object shields the escape route from the source of the alarm situation, the escape route may pass by the source, provided the object is located between the source and the escape route.

The embodiment just described with the alarm situation signal can be combined with the embodiment described above, in which the navigation unit calculates an updated escape route and generates an updated escape route description for the updated escape route. For example, receiving the alarm situation signal triggers the navigation unit to calculate an updated escape route. In one implementation of this combination, the navigation unit calculates the updated escape route and generates the updated escape route description depending on a trigger criterion. This trigger criterion depends on the geoposition of the source of the alarm situation and on the current geoposition of the user, optionally also on the description of the spatial area.

In the following, this disclosure is described on the basis of an exemplary embodiment.

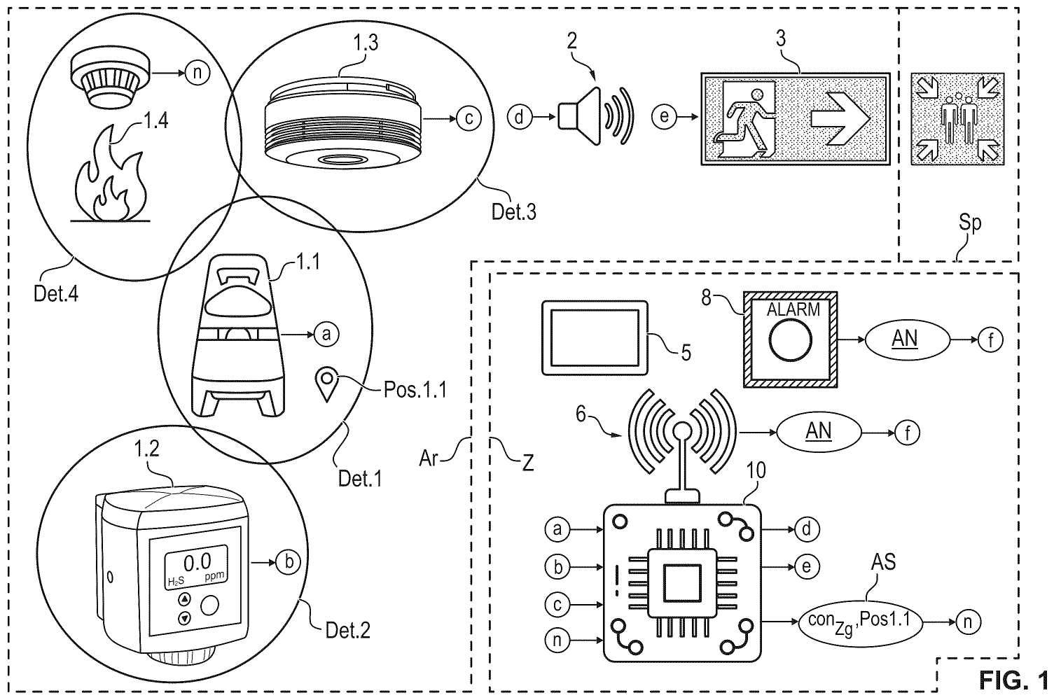

FIG. 1 shows, by way of example, a plurality of devices in a spatial area Ar to be monitored. In this spatial area Ar, humans are present or can at least temporarily be present. Examples of such a monitored spatial area Ar include public spaces and facilities, vehicles, buildings, or industrial plants. In addition, FIG. 1 shows a safe target position, for example a meeting point Sp or a shelter, outside the spatial area Ar, along with a central rescue center Z, in which at least one operator is working, outside the spatial area Ar. In one embodiment, a plurality of safe target positions outside the spatial area Ar are specified, for example a plurality of meeting points and/or at least one meeting point and a shelter. A safe target position can also be located in the spatial area Ar.

In this spatial area Ar, at least one gas can occur that, at a sufficiently high concentration, is flammable and/or toxic and/or harmful to humans in some other way. The harmful gas can, for example, be smoke from a fire and cause smoke poisoning. The harmful gas can also be flammable or toxic and escape, e.g., from a leak or an open container. It is also possible that the concentration of oxygen in the spatial area Ar is too low, which is also known to be dangerous for humans. In the following, reference is made in general to target gas, wherein the term “target gas” can refer to both a gas that is harmful to humans and a gas that is vital to humans.

Two stationary gas warning devices 1.1, 1.2 are installed at two locations spaced apart from each other. By way of example, the geoposition Pos.1.1 of the gas warning device 1.1 is shown in FIG. 1. The term “stationary device” specifies that the device is configured to be installed and used in one location. It is possible that a stationary device is initially used at a first location, then moved to a second location and then used at the second location.

The or each stationary device comprises a communication unit and is configured to transmit a signal to a spatially remote receiver by means of this communication unit. The communication unit is configured to transmit the signal, in particular by wire or wirelessly via radio waves. The signal comprises information about a measurement result of the device. The stationary device does not necessarily comprise its own output unit, which outputs the measurement result in at least one form perceptible to a human.

Each gas warning device 1.1, 1.2 has a spatial detection range Det.1, Det.2. Each gas warning device 1.1, 1.2 is configured to measure the concentration of at least one target gas in its respective detection range Det.1, Det.2. The detection ranges Det.1, Det.2 along with detection ranges of further sensors, some of which are described below and some of which are not shown, together cover at least that part of the spatial area Ar in which humans can be present.

Each gas warning device 1.1, 1.2 is configured to generate a signal. This signal comprises information about the measured target gas concentration. In one embodiment, the signal comprises information as to whether the measured target gas concentration is within or outside a given value range. In the case of a harmful gas, the signal usually comprises information as to whether or not the target gas concentration is above or below a given upper limit. Accordingly, for a vital gas, the signal comprises the information as to whether or not the target gas concentration is below or above a given lower limit. Each upper limit is given in such a way that no danger to humans can occur if the target gas concentration is less than or equal to the upper limit. Accordingly, each lower limit is given in such a way that no hazard can occur if the target gas concentration is above the lower limit. In another embodiment, the signal comprises an identifier for the measured target gas concentration. These embodiments can be combined with one another.

In one embodiment, an upper concentration limit is given for each harmful target gas, for example in ppm (parts per million). In one deviation, a larger and a smaller upper limit are given for at least one harmful target gas. If this harmful target gas occurs in conjunction with at least one other specified harmful target gas, the smaller lower limit applies, otherwise the larger upper limit applies. For example, for carbon monoxide (CO) and hydrogen cyanide (HCN), a respective smaller upper limit is given if these two harmful target gases occur together, otherwise a respective larger upper limit is given.

It is possible that all the gas warning devices 1.1, 1.2 are configured to detect the same target gas. It is also possible that the gas warning devices 1.1, 1.2 as a whole are configured to detect at least two different target gases.

A stationary smoke detector 1.3 is configured to detect an indication of the occurrence of smoke. As well known, smoke is often an indication of fire. The smoke detector 1.3 also has a detection range Det.3. A stationary flame detector 1.4 is configured to detect the occurrence of flames and heat in its detection range Det.4. Optionally, a heat detector (not shown) is configured to detect the occurrence of extreme heat. It is also possible that a water level sensor, also not shown, is configured to detect the occurrence of a rising water level that is therefore dangerous for humans, for example flooding in a body of water or in a building.

In the exemplary embodiment shown, two gas warning devices 1.1, 1.2, a smoke detector 1.3, and a flame detector 1.4 are used. Of course, other numbers of gas warning devices, smoke detectors, flame detectors, and other devices are also possible.

Preferably, each gas warning device 1.1, 1.2 and the smoke detector 1.3 comprise a respective measuring chamber, and the measuring chamber is configured to accommodate a gas sample from the detection range Det.1, Det.2, Det.3. Different detection principles or measuring principles as to how a gas warning device 1.1, 1.2 is configured to detect a target gas in a gas sample and/or to measure the concentration of a target gas in the gas sample are possible. The two gas warning devices 1.1, 1.2 can apply the same measuring principle or different measuring principles. For example, a radiation source emits electromagnetic radiation or sound into the measuring chamber, a target gas in the measuring chamber attenuates the radiation or sound in a specific wavelength range, and a detector measures the intensity of incident radiation or incident sound in this wavelength range. The measured intensity correlates with the target gas concentration. The smoke detector 1.3 can also apply a corresponding measuring principle.

A signal-processing alarm unit 10 in the central rescue center Z receives a respective signal from each of the two gas warning devices 1.1, 1.2, the smoke detector 1.3, and the flame detector 1.4. In the exemplary embodiment, this signal comprises information about the respective geoposition of this sensor and optionally a timestamp for a measurement.

In one embodiment, the received signal of a gas warning device 1.1, 1.2 contains the information about a measured target gas concentration. The alarm unit 10 decides whether this target gas concentration is above the given upper limit (harmful gas) or below the lower limit (vital gas). In another embodiment, the gas warning device 1.1, 1.2 itself decides whether the target gas concentration is above the upper or below the lower limit, and the signal contains information about this result. The signal of the smoke detector 1.3 and the signal of the flame detector 1.4 contain at least the information as to whether smoke or fire, resp., has occurred.

The term “alarm situation” is used below. An alarm situation has occurred if at least one target gas concentration is above the given upper or below the lower limit and/or if smoke and/or flames have been detected. The alarm unit 10 thus detects the event that at least one alarm situation has currently occurred.

In one embodiment, at least one image recording device (not shown) repeatedly generates images of a part of the spatial area. These images are transmitted to the central rescue center Z and output there on a screen 5. An operator monitors the output images and decides whether an alarm situation has occurred.

The alarm unit 10 actuates (controls) an output unit 2. Depending on the actuation, this output unit 2 can output messages that can be perceived by a human, in particular acoustically. In particular, the output message describes measures that must be taken now. One measure is that the monitored spatial area Ar is to be evacuated.

A stationary display unit 3 indicates where to go in order to leave the now dangerous area Ar in a form perceptible to a human, wherein the display unit 3 in particular visually indicates the direction. In the shown example, the display unit 3 visually indicates a direction to a safe target position, for example to the meeting point Sp. In one embodiment, the alarm unit 10 actuates (controls) the display unit 3. In order to reduce the risk of a human not perceiving the indicated direction, the actuated output unit 3 changes its state and lights up or flashes.

These actuated devices 2, 3 are only understood by way of example.

If the alarm unit 10 has detected an alarm situation, it generates an alarm message AN, which preferably comprises automatically generated information about the alarm situation. This alarm message AN is emitted via radio waves and/or transmitted via cable, preferably via broadcasting. Any suitable receiver within a radius of the alarm unit 10 receives the alarm message AN.

In one implementation, the alarm unit 10 generates during an alarm situation not only the alarm message AN but also an alarm situation signal AS.

This alarm situation signal AS comprises a computer-evaluable characterization of the alarm situation, for example an impermissible target gas concentration or smoke or flames, along with an identifier of the geoposition of the sensor that detected the alarm situation.

Optionally, the alarm message AN and/or the alarm situation signal AS also comprises information as to whether a pre-alarm or a main alarm is being output. In the event of a main alarm, the spatial area Ar must be evacuated immediately. A pre-alarm is an indication that a main alarm may be triggered soon.

By way of example, an alarm situation signal AS is shown in FIG. 1. The alarm situation signal AS contains an identifier of an alarm situation, in this example an impermissible concentration of a target gas, along with the geoposition Pos.1.1 of the gas warning device 1.1 that has measured this impermissible target gas concentration.

An operator can also activate an alarm activation unit 8, for example if a bomb warning is received or a severe thunderstorm is imminent, or an evacuation exercise is to be performed. An embodiment with an image recording device was described above. This embodiment makes the following sequence possible: The operator has decided that an alarm situation exists. The operator made this decision after visually evaluating images of the image recording device, which are displayed on screen 5. For example, an operator has detected in an image that a water level is rising, and decides that this constitutes an alarm situation.

The activation of the alarm activation unit 8 causes the alarm unit 10 to be actuated. Thereupon, the alarm unit 10 triggers the step, as described above, that the output unit 2 and the visual display unit 3 output messages and the alarm message AN is generated and broadcast and/or transmitted in another way.

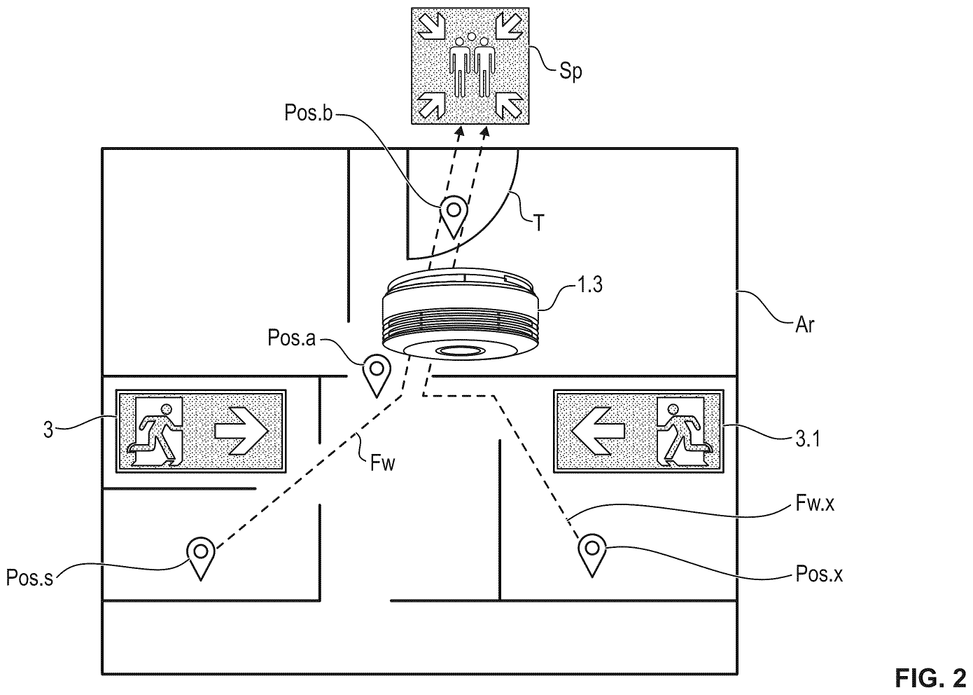

FIG. 2 shows, by way of example, a monitored spatial area Ar, here a floor of a building, wherein the spatial area Ar is represented by a floor plan. The safe target position, here the meeting point Sp, is located outside this building. An escape route Fw is marked, which starts at a starting geoposition Pos.s and leads out of the building Ar through a door T to the meeting point Sp. This escape route Fw initially leads past the display unit 3 and then under the smoke detector 1.3. Two intermediate geopositions Pos.a and Pos.b on the escape route Fw are marked. In addition, a further escape route Fw.x is marked, which starts at a starting geoposition Pos.x and leads past a further display unit 3.1 and under the smoke detector 1.3.

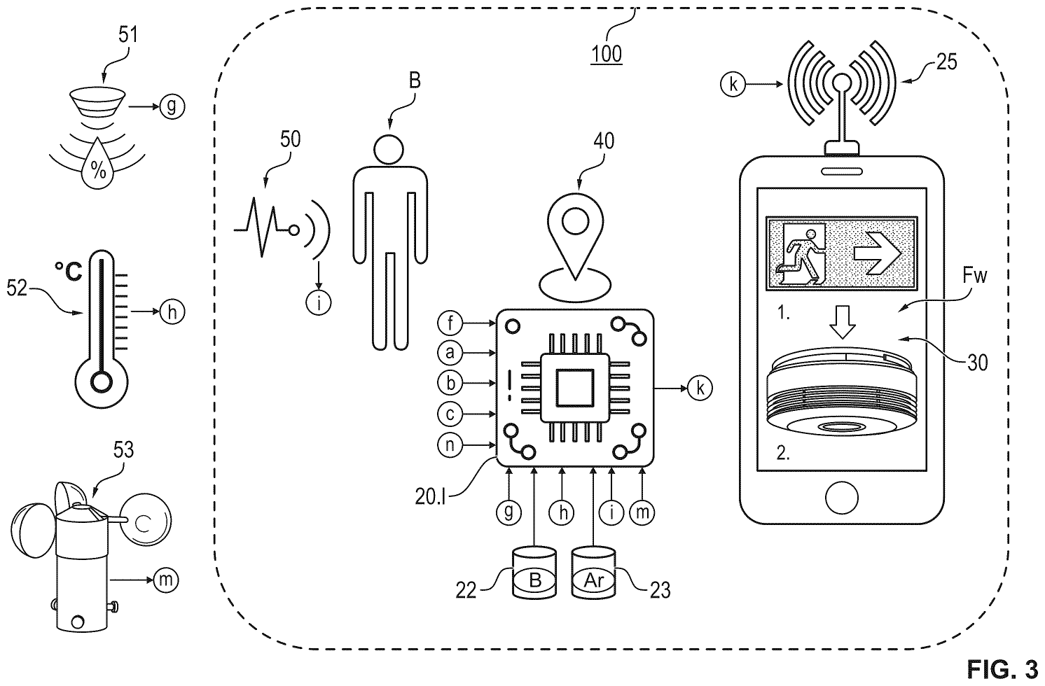

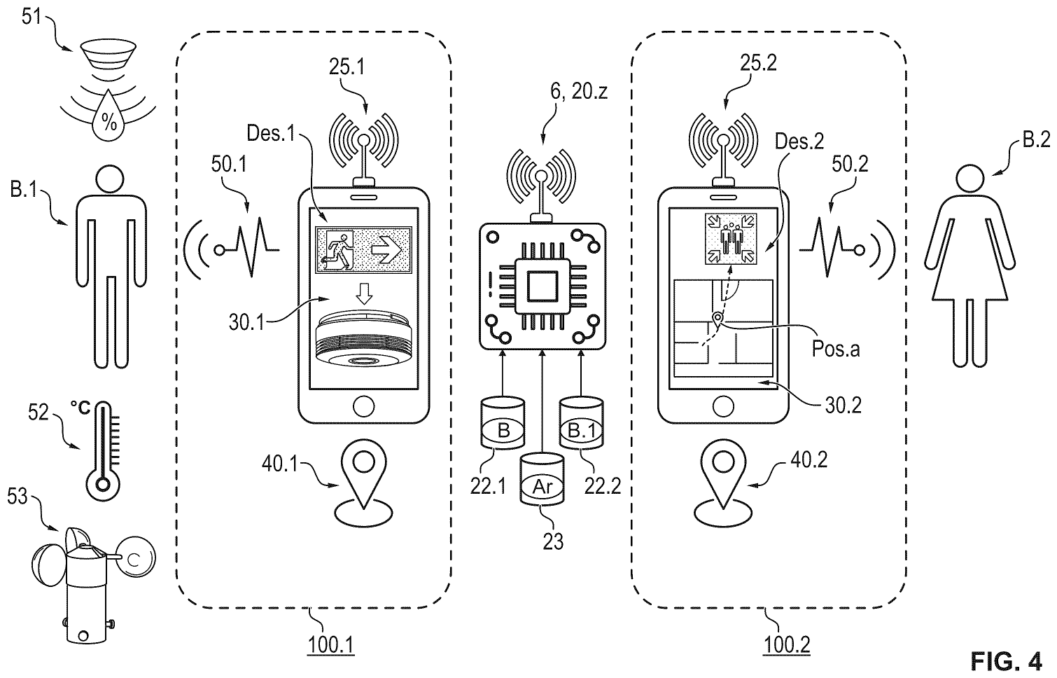

FIG. 3 and FIG. 4 show, by way of example, two different embodiments of the escape assistance arrangement of the exemplary embodiment. The same reference signs have the same meanings. Unless expressly stated otherwise, the following description refers to both embodiments.

The escape assistance arrangement includes
at least one portable escape assistance device 100, 100.1, 100.2,
at least one signal-processing navigation unit 20.l, 20.z, and
a plurality of sensors.

A user B, B.1, B.2 carries the escape assistance device 100, 100.1, 100.2 with him/her, for example on protective equipment or other clothing. In one embodiment, the escape assistance device 100, 100.1, 100.2 comprises a smartphone. It is also possible that a software program, in particular an app, is installed on a commercially available smartphone or smart watch, thus turning the smartphone/smart watch into an escape assistance device 100, 100.1, 100.2.

In the embodiment shown in FIG. 3, the navigation unit 20.l belongs to the portable escape assistance device 100, and it is therefore referred to below as the local navigation unit 20.l. For example, the navigation unit 20.l uses a processor and further components of the smartphone. It is also possible that some components of the escape assistance device 100 are arranged outside the smartphone. For clarity, some components are shown side by side in FIG. 3. It is possible that the smartphone provides all components of the escape assistance device 100.

In the embodiment according to FIG. 4, the navigation unit 20.z is arranged outside the or each escape assistance device 100.1, 100.2, preferably as a central stationary device, and is referred to below as the central navigation unit 20.z. It is possible that the same signal-processing device carries out both the functions of the alarm unit 10 and the functions of the central navigation unit 20.z. In an alternative implementation, the central navigation unit 20.z is a component of one of the escape assistance devices 100.1, 100.2, while the other escape assistance devices do not comprise an own navigation unit.

By way of example, FIG. 4 shows two escape assistance devices 100.1 and 100.2, which are carried by a user B.1 and another user, here the user B.2. Each escape assistance device 100.1, 100.2 is at least temporarily in a bidirectional data connection with the central navigation unit 20.z. For example, the data connection is established if the following two conditions are met: The user B.1, B.2 has switched on his/her escape assistance device 100.1 100.2. Said user is in the spatial area Ar.

The following components belong to the escape assistance device 100, 100.1, 100.2, which the user B, B.1, B.2 carries:
a respective vital parameter sensor 50, 50.1,50.2,
a respective geoposition sensor 40, 40.1, 40.2,
a respective user interface 30, 30.1, 30.2 having an input unit and an output unit, and
optionally, a respective camera.

The escape assistance device 100, 100.1, 100.2 also comprises a respective communication unit 25, 25.1, 25.2. This communication unit 25, 25.1, 25.2 receives messages from spatially remote transmitters via radio waves. The central navigation unit 20.z comprises a communication unit 6. In the embodiment according to FIG. 4, data are exchanged between the escape assistance device 100.1, 100.2 and the central navigation unit 20.z with the aid of the communication units 25.1, 25.2 and 6.

A message received by the communication unit 25 of the escape assistance device 100 according to FIG. 3 and by the communication unit 6 of the central navigation unit 20.z according to FIG. 4 is an alarm message AN from the alarm unit 10. It is possible, but thanks to the central navigation unit 20.z not necessary, that the escape assistance device 100.1, 100.2 also directly receives and processes the alarm message AN.

The user B, B.1, B.2 wears the vital parameter sensor 50, 50.1, 50.2 on his/her body. The vital parameter sensor 50, 50.1, 50.2 measures at least one vital parameter of the user B, B.1, B.2, in particular his/her heart rate, his/her respiratory rate, his/her blood pressure and/or the oxygen saturation of his/her blood. The vital parameter sensor 50, 50.1, 50.2 is, for example, a component of a device that the user B, B.1, B.2 wears on a wrist or arm. The vital parameter sensor 50, 50.1, 50.2 generates a signal that contains respective information about the or each measured vital parameter. This signal is transmitted to the navigation unit 20.l, 20.z via a wired data connection within the escape assistance device 100 (embodiment according to FIG. 3) or via a wireless data connection via radio waves (embodiment according to FIG. 4).

The geoposition sensor 40, 40.1, 40.2 measures its own geoposition and thus, with sufficient accuracy, the geoposition of the user B, B.1, B.2, who wears the escape assistance device 100, 100.1, 100.2 to which the geoposition sensor 40, 40.1, 40.2 belongs to.

Preferably, the user interface 30, 30.1, 30.2 comprises a touch-sensitive screen, for example the screen of the respective smartphone/smart watch. On this screen, the escape assistance device 100, 100.1, 100.2 is configured to visually display images and other presentations. In the following, the term output unit (display unit) is used and the reference signs 30, 30.1, 30.2 are used. The output unit is provided by the user interface 30, 30.1, 30.2. In one embodiment, the output unit 30, 30.1, 30.2 of the escape assistance device 100, 100.1, 100.2 additionally comprises at least one of the following devices:
optical signal elements,
a loudspeaker,
optional further acoustic signal elements,
a head-up display,
glasses for virtual reality (VR),
a haptic alarm unit, in particular an alarm unit that outputs an alarm by vibration.

The local navigation unit 20.l processes messages received by the escape assistance device 100 by means of the communication unit 25, including the alarm message AN. The central navigation unit 20.z processes messages that the central navigation unit 20.z has received by means of the communication unit 6.

The navigation unit 20.l, 20.z also processes various signals. These include, on the one hand, signals generated by a sensor of the escape assistance device 100, 100.1, 100.2 itself, and, on the other hand, signals generated by at least one spatially remote sensor. The communication unit 6, 25 receives various messages, each having a signal, from at least one spatially remote sensor. In the exemplary embodiment, each signal generated by a spatially remote sensor comprises an identifier of the current geoposition of this sensor. If the sensor is used as a stationary device, this current geoposition can be measured in advance when the sensor is positioned. It is also possible that the sensor is carried by a person and that the person is also connected to a geoposition sensor.

The navigation unit 20.l, 20.z processes, on the one hand, a respective signal received from each of the vital parameter sensor 50, 50.1, 50.2 and the geoposition sensor 40, 40.1, 40.2.

On the other hand, the navigation unit 20.l, 20.z receives and processes an alarm situation signal from each of the two stationary gas warning devices 1.1 and 1.2, the smoke detector 1.3, and the flame detector 1.4, which are shown by way of example in FIG. 1. It is possible that the navigation unit 20.l, 20.z receives the signal directly from the respective sensor 1.1, 1.2, 1.3, 1.4.

In the exemplary embodiment, however, the navigation unit 20.l, 20.z receives and processes the alarm situation signal generated by the alarm unit 10. As already explained above, an alarm situation signal AS comprises, on the one hand, information about a detected alarm situation, for example an impermissible target gas concentration or smoke or flames, and, on the other hand, an identifier of the geoposition of the sensor 1.1, 1.2, 1.3, 1.4 that has detected this alarm situation. By way of example, the alarm situation signal AS is shown in FIG. 1. The embodiment that the navigation unit 20.l, 20.z receives the alarm situation signal from the alarm unit 10 and not directly from the sensor 1.1, 1.2, 1.3, 1.4 eliminates the need to define a common transmission protocol for each sensor 1.1, 1.2, 1.3, 1.4 and for the navigation unit 20.l, 20.z. Furthermore, it is not necessary that the navigation unit 20.l, 20.z evaluates a measured value of a sensor 1.1, 1.2, 1.3, 1.4 in order to decide for itself whether or not this measured value indicates an alarm situation.

Note: In the exemplary embodiment, the alarm unit 10 is a stationary device that transmits via broadcasting an alarm message AN and an alarm situation signal AS to a plurality of receivers, including the or each navigation unit 20.l, 20.z. It is also possible that the same device carries out both the functions of the alarm unit 10 and the functions of a navigation unit 20.l, 20.z. This device can be a stationary device or a component of an escape assistance device.

In addition, the navigation unit 20.l, 20.z of the exemplary embodiment receives and processes a signal of a humidity sensor 51, a signal of a temperature sensor 52 and a signal of a wind sensor 53. The humidity sensor 51 measures an indicator for the ambient humidity, the temperature sensor 52 measures an indicator for the temperature, and the wind sensor 53 measures an indicator for the wind direction and wind strength, all in their respective environment. In one implementation, the sensors 51, 52 and 53 are arranged spatially remote from the escape assistance device 100, 100.1, 100.2, preferably as stationary devices; in another implementation, they are two components of the escape assistance device 100, 100.1, 100.2. It is possible that the navigation unit 20.l, 20.z receives and processes signals from further sensors not shown here.

The navigation unit 20.l, 20.z has, at least temporarily, read access to an area data memory 23. A map of the monitored spatial area Ar is stored on the area data memory 23 in a computer-evaluable form. Preferably, in addition to a site plan of the spatial area Ar, this map comprises information on bottlenecks in the spatial area Ar, for example doors, passageways, or stairs, along with information on differences in altitude. Optionally, the stored map comprises a respective floor plan for each floor of a multi-story building. The map further shows the position of the or each safe target position Sp relative to the spatial area Ar.

Furthermore, the local navigation unit 20.l of the exemplary embodiment has, at least temporarily, read access to a user data memory 22. This user data memory 22 stores various pieces of information about the user B. In order to avoid unauthorized access to the information on the user data memory 22, the navigation unit 20.l only has access to the information in the user data memory 22 if the user B has previously been successfully authenticated. The information stored on the user data memory 22 includes the following information in the exemplary embodiment:
What visual impairments does the user B have?
What hearing impairments does the user B have?
What impairments does the user B have in walking and/or running?
What impairments does the user B have in breathing?
Which natural languages can the user B read and understand?
With which spatial areas the user B is familiar?
Which safety training courses has the user B completed (passed)?

In one embodiment, the escape assistance device 100 has determined this information in advance after the user B has been successfully authenticated through read access to a central database. Of course, it is possible that no information whatsoever about a restriction is stored about a user B.

Accordingly, the central navigation unit 20.z has, at least temporarily, read access to a respective user data memory 22.1, 22.2, wherein information about the user B.1 or the user B.2 is stored on the user data memory 22.1, 22.2. This information can be physically stored on a single central data memory to which the central navigation unit 20.z has read access. It is also possible that the information about a user's impairments is stored on an escape assistance device 100, 100.1, 100.2 or on another device that the user B.1, B.2 carries, for example on a smartphone or a smart watch of the user B.1, B.2.

The user B, B.1, B.2 can make inputs with the aid of the input unit of the user interface 30, 30.1, 30.2. As a result, the user B, B.1, B.2 can enter further information about himself/herself that is currently valid. This includes the following information, which the user B, B.1, B.2 can enter before an alarm message AN arrives:
What personal protective equipment is the user B, B.1, B.2 currently wearing on his/her body? Examples include a safety helmet, protective clothing, a compressed air breathing apparatus, or an escape hood.
Is the user B, B.1, B.2 currently injured? If so: how?

In addition, the user B, B.1, B.2 can make entries about the escape route, in particular an entry that an escape route is currently impassable.

The navigation unit 20.l, 20.z evaluates incoming messages and signals and decides whether an alarm situation has currently occurred for at least one user B, B.1, B.2 in the monitored spatial area Ar. In particular, the navigation unit 20.l, 20.z checks whether an alarm message AN has arrived. This alarm message AN indicates that an alarm situation has occurred for each user B, B.1, B.2 in the spatial area Ar.

In one embodiment, the possibility is taken into account that an alarm situation exists for a specific user B, B.1, B.2 even though no general alarm situation has occurred and no alarm message AN has therefore been generated. For example, the information that the user B, B.1, B.2 has a breathing impairment is stored on the corresponding user data memory 22, 22.1, 22.2. Even at a relatively low smoke exposure, the user must therefore leave the spatial area Ar. Or the user B, B.1, B.2 currently has a state that represents an alarm situation for this user B, B.1, B.2. The navigation unit 20.l, 20.z determines this current user state depending on a signal of the vital parameter sensor 50, 50.1, 50.2 of this user.

In one embodiment, the navigation unit 20.l, 20.z automatically decides that the user B, B.1, B.2 must immediately leave the spatial area Ar due to his/her current physical state and/or due to the current situation in the spatial area Ar. In order to make this decision, the navigation unit 20.l, 20.z evaluates a signal of the vital parameter sensor 50, 50.1, 50.2 that the user B, B.1, B.2 carries as part of the escape assistance device 100, 100.1, 100.2. In addition, the navigation unit 20.l, 20.z evaluates information about the user B, B.1, B.2 that is stored on the user data memory 22, 22.1, 22.2.

According to this embodiment, the navigation unit 20.l, 20.z additionally receives and processes an alarm situation signal AS from the alarm unit 10 or from each gas warning device 1.1, 1.2 and from the or each smoke detector 1.3 and from the or each flame detector 1.4. It also receives and processes the signal or at least one signal of the vital parameter sensor 50, 50.1, 50.2. The navigation unit 20.l, 20.z evaluates these signals and decides whether an alarm situation has currently occurred for the user B, B.1, B.2.

In one implementation, the navigation unit 20.l, 20.z has derived a value range for each target gas that can occur in the spatial area Ar and whose occurrence is detected by a gas warning device 1.1, 1.2. This value range depends on a given upper or lower limit and, in one embodiment, on information about a restriction of the user B, B.1, B.2, wherein this information is stored on the user data memory 22, 22.1, 22.2. According to this implementation, the received alarm situation signal AS comprises an identifier of the measured target gas concentration. The navigation unit 20.l, 20.z decides whether or not the measured target gas concentration lies within the value range permitted for this user B, B.1, B.2.

As just explained, the navigation unit 20.l, 20.z detects that an alarm situation exists for every human in the spatial area Ar or at least for a specific user B, B.1, B.2. If the navigation unit 20.l, 20.z receives an alarm message AN, an alarm situation exists for every human in the spatial area Ar. The navigation unit 20.l, 20.z itself detects a special alarm situation for a user B, B.1, B.2, for which purpose it preferably evaluates a signal of the vital parameter sensor 50, 50.1, 50.2 and optionally further signals and/or stored information.

In response to the fact that an alarm situation is detected for every or at least for one user in the spatial area Ar, the navigation unit 20.l, 20.z calculates a respective escape route Fw for each user B, B.1, B.2 who must leave the spatial area Ar immediately. This escape route Fw starts at the current geoposition Pos.s of the user B, B.1, B.2 (more precisely: at the current geoposition Pos.s of the corresponding geoposition sensor 40) and leads to a safe target position outside the spatial area Ar, in this case to the meeting point Sp. In one embodiment, a plurality of safe target positions is specified, and the escape route Fw leads to one of these safe target positions. It is possible that the same escape route Fw is calculated for different users.

In certain embodiments, the navigation unit 20.l, 20.z calculates at least one escape route candidate. The or each escape route candidate starts at the current geoposition Pos.s of the geoposition sensor 40, 40.1, 40.2 and leads to the or a safe target position Sp. It is possible that different escape route candidates start at the same current geoposition Pos.s and lead to the same safe target position Sp but on different ways.

In order to find an escape route candidate, the navigation unit 20.l, 20.z uses the map stored on the area data memory 23, which map describes the spatial area Ar and the or each safe target position Sp. The navigation unit 20.l, 20.z calculates a rating for each escape route candidate. The following describes which parameters are taken into account when rating an escape route candidate. In order to calculate the rating for an escape route candidate, the navigation unit 20.l, 20.z applies a computer-evaluable rating rule, wherein the rating rule has as a variable at least one of the parameters described below.

By evaluating the computer-evaluable map stored on the area data memory 23, the navigation unit 20.l, 20.z determines how long a user B, B.1, B.2 needs on average to get from his/her current geoposition Pos.s via this escape route candidate to a safe target position Sp. The expected time period required takes into account the length of the escape route candidate along with information about bottlenecks and information about differences in altitude. One parameter for rating an escape route candidate is the expected time duration.

As already explained, the navigation unit 20.l, 20.z receives signals from each gas warning device 1.1, 1.2, each smoke detector 1.3, each flame detector 1.4, and any other device that monitors the spatial area Ar. The navigation unit 20.l, 20.z checks whether an escape route candidate leads through a subregion of the spatial area Ar in which a target gas with an impermissible concentration or smoke or flames or other detected hazards occur. Even in a region comprising a safe target position Sp outside the spatial area Ar, an impermissible (harmful) target gas concentration or smoke or flames may occur.

Preferably, the navigation unit 20.l, 20.z not only determines a current hazard that occurs for a user B, B.1, B.2 on an escape route candidate due to an impermissible target gas concentration or smoke or flames, but also makes a prediction for a future development of the target gas concentration or smoke or flames. For this purpose, the navigation unit 20.l, 20.z extrapolates the particular sequence of measured values in the respective signals of each gas warning device 1.1, 1.2, each smoke detector 1.3, each flame detector 1.4, and each other sensor. In one embodiment, the navigation unit 20.l, 20.z additionally uses a signal of the wind sensor 53. By evaluating this signal and the stored map, the navigation unit 20.l, 20.z predicts at least approximately where a cloud containing a harmful target gas or smoke will move to. In doing so, the navigation unit 20.l, 20.z distinguishes whether an escape route candidate leads through a building or through open terrain. If an escape route candidate is currently contaminated by an impermissible target gas concentration or smoke or flames or will be contaminated in the future, the escape route candidate receives a lower rating.

Note: A contaminated escape route candidate is not automatically excluded as an escape route. On the one hand, it is possible that there is currently no less contaminated or even uncontaminated escape route leading out of the spatial area Ar. On the other hand, it is possible that the user B, B.1, B.2 can use this escape route despite the contamination, thanks to his/her protective equipment.

The navigation unit 20.l, 20.z further evaluates signals from each humidity sensor 51, each temperature sensor 52, each wind sensor 53, and each further environmental condition sensor. Adverse environmental conditions can also result in an escape route candidate receiving a lower rating. For example, an escape route candidate will receive a lower rating if a segment of the escape route candidate passes through a region under water due to precipitation or flooding, or that is subject to strong winds or high temperatures, or that is not illuminated by sunlight or artificial lighting.

In addition, the navigation unit 20.l, 20.z uses information about the user B, B.1, B.2 to calculate a rating for an escape route candidate. This information may be specific to these users B, B.1, B.2 and is stored on the user data memory 22, 22.1, 22.2. Some examples of how information about a user B, B.1, B.2 is used to rate an escape route candidate:

If a user B, B.1, B.2 has—according to the stored information—an impairment in walking, an escape route candidate receives a low rating if the escape route Fw is poorly suited for a human with walking difficulties, for example if it leads over stairs or slopes or through a flooded area. Such a candidate is also not ruled out from the outset, in particular because there might not be any other candidate available.

An escape route candidate may be poorly suited if a segment of the escape route candidate is very narrow and the user B, B.1, B.2 carries relatively bulky protective equipment. This leads to a lower rating.

Conversely, if a user B, B.1, B.2 wears appropriate protective equipment, for example an escape hood, an escape route candidate may be suitable even though the escape route candidate comprises a segment in which an impermissible target gas concentration or high heat is present. In one embodiment, the escape assistance device 100, 100.1, 100.2 requests the user B, B.1, B.2 to put on an escape hood and captures a corresponding confirmation from the user B, B.1, B.2 that the user has now actually put on the escape hood.

In one embodiment, if an alarm situation has occurred, a description of the area Ar to be monitored, for example a floor plan, is displayed on the screen 5 in the control center Z. This description includes the respective measured geoposition of each user B, B.1, B.2 of an escape assistance device 100, 100.1, 100.2 along with the calculated escape routes, as shown by way of example in FIG. 2. Optionally, an identifier of the respective measured current state of a user B, B.1, B.2 is additionally indicated on the screen 5. The output on the screen 5 makes it easier for an operator to initiate a rescue operation if necessary.

As just explained, for each user B, B.1, B.2 who must leave the spatial area Ar immediately, the navigation unit 20.l, 20.z calculates an escape route Fw that starts at the current geoposition of the user B, B.1, B.2 and leads to a safe target position Sp. FIG. 2 shows, by way of example, an escape route Fw that starts at the geoposition Pos.s and leads to the meeting point Sp outside the spatial area Ar.

The navigation unit 20.l, 20.z generates an escape route description, which describes the calculated escape route Fw in at least one way perceptible to a human and actuates the escape assistance device 100, 100.1, 100.2. The actuated escape assistance device 100, 100.1, 100.2 outputs the generated escape route description on its output unit 30, 30.1, 30.2.

The escape route description depends on the current state of the user B, B.1, B.2. The navigation unit 20.l, 20.z determines the current state of a user B, B.1, B.2, for which purpose it uses a signal of the vital parameter sensor 50, 50.1, 50.2. It is therefore possible that the navigation unit 20.l, 20.z generates a plurality of different escape route descriptions for the same escape route Fw. This is described below with reference to FIG. 4.

In the situation shown by way of example in FIG. 4, two users B.1, B.2 are in the same spatial area Ar when an alarm message AN is generated. The two geopositions where these two users B.1, B.2 are located at this time point match the initial geoposition Pos.s (shown in FIG. 2) with sufficient accuracy.

The central navigation unit 20.z receives the alarm message AN and thereupon calculates, in this example, the same escape route Fw for both users B.1, B.2. The navigation unit 20.z generates an escape route description Des.1 for the user B.1 and a different escape route description Des.2 for the user B.2. The two escape route descriptions Des.1, Des.2 comprise different presentation (display) elements.

In the example shown, the central navigation unit 20.z evaluates a signal received from of the vital parameter sensor 50.1 of the user B.1 and a signal received from the vital parameter sensor 50.2 of the user B.2. The navigation unit 20.z detects a significantly increased respiratory rate and an increased heart rate of the user B.1, while the user B.2 has a normal respiratory rate and a normal heart rate. From this, the navigation unit 20.z automatically concludes that the user B.1 is currently in a panic state, but the user B.2 is not. The escape route description Des.1 is therefore generated such that it is understandable even for a user who is in a panic state, while the escape route description Des.2 comprises more information.

In this example, the escape route description Des.1 for the user B.1 being in a panic state comprises only two images, namely an image of the visual display unit 3 and an image of the smoke detector 1.3, along with an arrow indicating that the user B.1 must initially walk past the display unit 3 and then past the smoke detector 1.3 in order to leave the spatial area Ar and reach the meeting point Sp. As a rule, even a user B.1 who is in a panic state is able to understand such a description and behave accordingly. The escape route description Des.2 for the user B.2, on the other hand, comprises a floor plan of the spatial area Ar, a representation of the meeting point Sp and a presentation of the escape route Fw in the floor plan.

As already explained, in the shown example, the navigation unit 20.z decided that the user B.1 is in a panic state, but the user B.2 is not. In one embodiment, the escape route description Des.2 for the user B.2 additionally comprises a description of a current geoposition of the user B.1 along with an indication that the user B.1 is in a panic state. As a result, the user B.2 is put into the position to locate the user B.1 in a panic state and take the user B.1 along his/her own escape route Fw to the meeting point Sp. Of course, it is the decision of the user B.2 whether or not to do so.

In one embodiment, the navigation unit 20.l, 20.z continuously determines the current geoposition of the user B, B.1, B.2. For this purpose, the navigation unit 20.l, 20.z uses a signal of the corresponding geoposition sensor 40, 40.1, 40.2. The navigation unit 20.l, 20.z inserts a characterization of the determined current geoposition of the user B, B.1, B.2 into the escape route description Des.2 with the floor plan. By way of example, FIG. 4 shows that a characterization of the current position Pos.a of the user B.2 is entered in the escape route description Des.2.

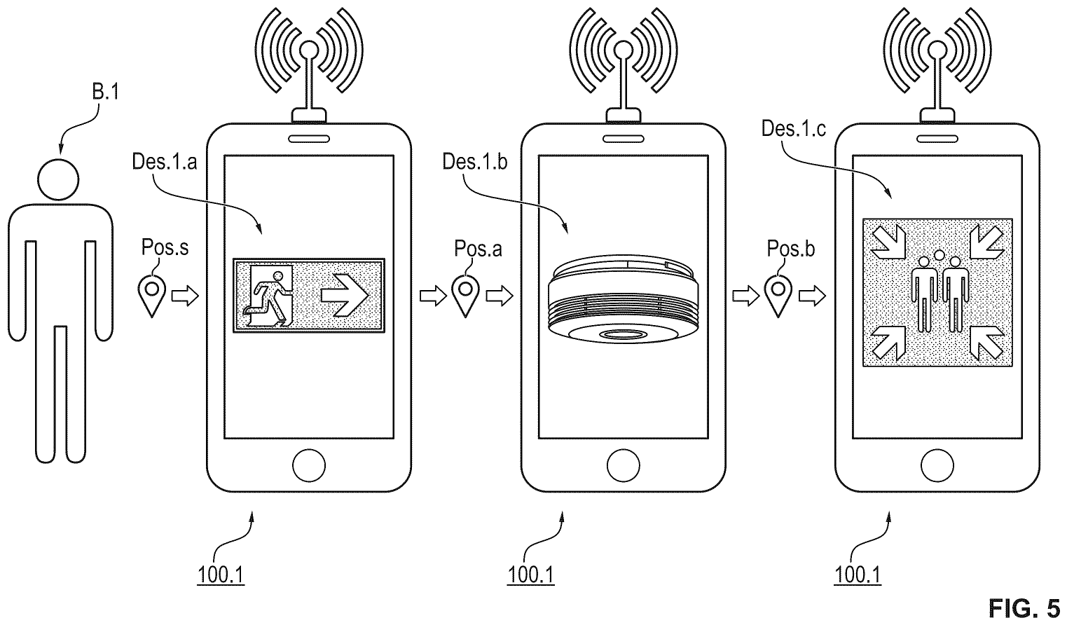

FIG. 5 shows a possible implementation of the escape route description Des.1, which the navigation unit 20.l, 20.z generates for the user B.1 in a panic state and which is output on the output unit 30.1 of the escape assistance device 100.1. This escape route description Des.1 comprises an image sequence of three images Des.1.a, Des.1.b, Des.1.c. An image set, including the three images Des.1.a, Des.1.b, Des.1.c, is stored on the area data memory 23. For each image Des.1.a, Des.1.b, Des.1.c, one geoposition is stored, namely the geoposition from which this image Des.1.a, Des.1.b, Des.1.c was generated.

The navigation unit 20.l, 20.z generates an image sequence, for which purpose it uses the calculated escape route Fw and the geopositions of the images Des.1.a, Des.1.b, Des.1.c of the image set. A user B.1 moving along the calculated escape route Fw sees the images Des.1.a, Des.1.b, Des.1.c of the image sequence in this order.

If the user B.1 is located at the starting geoposition Pos.s, the output unit 30.1 shows the image Des.1.a. This image Des.1.a shows the visual display unit 3 and is the first intermediate target on the escape route Fw. The image Des.1.a is shown until the user B.1 reaches the intermediate geoposition Pos.a, more precisely: until the current geoposition of the user B.1 deviates from the intermediate geoposition Pos.a by less than a given upper limit. Thereupon, the output unit 30.1 changes the display and now shows the image Des.1.b, namely an image of the smoke detector 1.3. As soon as the user B.1 reaches the intermediate geoposition Pos.b, the output unit 30.1 changes the display again and now shows the characterization of the meeting point Sp. In many cases, this escape route description Des.1 can be sufficiently reliably understood and implemented even by a user B.1 in a panic state, even in relatively poor lighting conditions.

As just explained with reference to FIG. 4 and FIG. 5, the navigation unit 20.l, 20.z generates two different escape route descriptions Des.1 and Des.2 for the same escape route Fw. The reason just mentioned for these different escape route descriptions Des.1 and Des.2 is the following: The navigation unit 20.l, 20.z detected that the user B.1 panicked, but the user B.2 did not, when the alarm message AN arrived. Another or additional reason is the following: According to information about the user B.2 stored on the data memory 22.2, the user B.2 is familiar with the spatial area Ar and can therefore use a floor plan in order to find the escape route Fw. However, such information is not stored about the user B.1.

It was described above with reference to FIG. 5 how the output unit 30.1 outputs the escape route description Des.1. The output unit 30.1 outputs an image Des.1.a, Des.1.b, Des.1.c, and it outputs a new image if the user B.1 has reached a specific geoposition Pos.a, Pos.b. For this purpose, the navigation unit 20.l, 20.z continuously determines the current geoposition of the user and actuates the output unit 30.1 as just described.

In a different embodiment, the output unit 30.1 outputs an image until the user B.1 has confirmed by a corresponding user input that the user has reached the imaged object 3, 1.3. The user interface providing the output unit 30.1 captures this user input, and the navigation unit 20.l, 20.z causes the output unit 30.1 to output the next image. These two implementations can be combined: The output unit 30.1 outputs the next image if the user B.1 has entered that the user has reached the object 3, 1.3 shown in the currently output image, or if the user B.1 has reached the geoposition of the image.

According to this disclosure, the particular escape route description Des.1, Des.2, that the navigation unit 20.l, 20.z generates and the output unit 30, 30.1, 30.2 outputs, depends on the current state of the user B, B.1, B.2 and/or on stored information about the user B, B.1, B.2. In one embodiment, a user B, B.1, B.2 can select, with the aid of a selection unit of the escape assistance device 100, 100.1, 100.2, which escape route description Des.1, Des.2 is to be generated and output. This user input overwrites a decision that the navigation unit 20.l, 20.z has made automatically. Note: As a rule, a user B, B.1, B.2 can only make this selection if the user B, B.1, B.2 is not in a panic state. It is also possible that the navigation unit blocks the selection unit if the navigation unit 20.l, 20.z has detected that the user B, B.1, B.2 is in a panic state. As a result, the navigation unit 20.l, 20.z prevents the user B, B.1, B.2 in a panic state from inadvertently selecting a different escape route description that is currently not suitable for him.

In one embodiment, the output unit 30, 30.1, 30.2 is additionally configured to output acoustic voice messages to the user 100, 100.1, 100.2. It is possible that an escape route description Des.1, Des.2 additionally comprises voice messages and that the output of the escape route description Des.1, Des.2 includes the output of the voice messages. For example, each image that is output according to the embodiment of FIG. 4 or FIG. 5 is additionally associated with a language file that describes the object shown. Particularly preferably, different language files in different languages are stored, and the navigation unit 20.l, 20.z selects a language file in a language that the user understands according to the stored user information.

As already explained, the navigation unit 20.l, 20.z determines the current geoposition Pos.s of the user B, B.1, B.2 at the time point at which the navigation unit 20.l, 20.z receives an alarm message AN and thereupon calculates an escape route Fw starting at the current geoposition Pos.s. For this determination, the navigation unit 20.l, 20.z uses a signal of the geoposition sensor 40, 40.1, 40.2.

Preferably, the navigation unit 20.l, 20.z continuously determines the current geoposition of the user B, B.1, B.2, at least until the user B, B.1, B.2 has reached the or a safe target position Sp. For this purpose, the navigation unit 20.l, 20.z uses a signal of the geoposition sensor 40, 40.1, 40.2. In one implementation, the navigation unit 20.l, 20.z determines the current geoposition with a fixed sampling frequency. In another embodiment, the navigation unit 20.l, 20.z determines the current geoposition with a lower sampling frequency as long as it has not received an alarm message AN and a specific user does not have to leave the spatial area Ar. This saves electrical energy. As soon as an alarm message AN has arrived or a user has to leave the spatial area Ar, the navigation unit 20.l, 20.z automatically switches to a mode with a higher sampling frequency. The higher energy consumption no longer plays a role in an alarm situation.

The navigation unit 20.l, 20.z compares the measured current geoposition of the user B, B.1, B.2 having the escape route Fw that the navigation unit 20.l, 20.z has calculated for this user B, B.1, B.2. If the navigation unit 20.l, 20.z detects that the user B, B.1, B.2 has deviated significantly from the calculated escape route Fw, the navigation unit 20.l, 20.z preferably responds to this detection as follows: The navigation unit 20.l, 20.z calculates an updated escape route, wherein the updated escape route starts at the current geoposition of the user B, B.1, B.2 and leads to a safe region. The navigation unit 20.l, 20.z generates a description of the updated escape route. This escape route description is in turn generated depending on the determined current state of the user B, B.1, B.2 and optionally on stored information about the user B, B.1, B.2.

It is possible that the navigation unit 20.l, 20.z determines the current state of the user B, B.1, B.2 only once, namely after receiving the alarm message AN. Preferably, however, the navigation unit 20.l, 20.z again determines the current state of the user B, B.1, B.2, for which purpose the navigation unit 20.l, 20.z again receives and evaluates the signal of the vital parameter sensor 50, 50.1, 50.2. It is possible that a user B, B.1, B.2 is now in a panic state or, conversely, is no longer in a panic state.

In one implementation, the navigation unit 20.l, 20.z checks whether there is any further indication that the user B.1, B.2 is in a panic state. A further indication is that the user B.1, B.2 is moving forward in a zigzag pattern without the escape route having a zigzag shape. If the user B.1, B.2 nevertheless moves forward “on average” along the calculated escape route, i.e., has not deviated too far from the escape route, the navigation unit 20.l, 20.z calculates, in one embodiment, a new escape route description for the previously calculated escape route, wherein the new escape route description is adapted to the detected state of the user B.1, B.2.

The possible situation that a user B.1, B.2 has left the calculated escape route is explained using the example of FIG. 2: The user B.1 in a panic state is to leave the spatial area Ar along the escape route Fw. However, the user B.1 leaves this escape route Fw and reaches the geoposition Pos.x. The navigation unit 20.l, 20.z calculates an updated escape route, which is designated Fw.x in FIG. 2, starts at the geoposition Pos.x and also leads to the meeting point Sp. The navigation unit 20.l, 20.z detects that the user B.1 is still in a panic state. The generated escape route description for the user B.1 describes the updated escape route Fw.x, is structured like the escape route description Des.1 of FIG. 4, and comprises an image of the further display unit 3.1 and an image of the smoke detector 1.3. The escape route description Des.1 can also be configured as described with reference to FIG. 5.

A further embodiment takes into account the possibility that a segment of a calculated escape route Fw is currently impassable. For example, the escape route Fw leads through a passage, and a door closes this passage and cannot be opened. Or a segment is flooded or heavily smoke-filled or impassable due to flames. This situation was not “known” to the navigation unit 20.l, 20.z when calculating the escape route Fw, for example because no sensor is able to detect this situation.

According to this embodiment, the user interface 30, 30.1, 30.2 of the escape assistance device 100, 100.1, 100.2 is configured to capture a user input with the content “Escape route blocked.” This user input is transmitted to the navigation unit 20.l, 20.z.

In one embodiment, the escape assistance device 100, 100.1, 100.2 is configured to implement the following sequence:
Using the camera of the escape assistance device 100, 100.1, 100.2, the user B, B.1, B.2 generates at least one image, which shows the blocked segment of the escape route Fw, for example a blocked door.
The blocked segment has since been made passable again or has become accessible again on its own, for example because floodwater has drained away.
The step in which the user enters the message “Escape route blocked” causes the following: The image of the blocked segment of the escape route Fw is transmitted to the navigation unit 20.l, 20.z.

In one implementation, the possibility is taken into account that the navigation unit 20.l, 20.z receives a user input that the escape route Fw is blocked, but, in reality, this escape route Fw is not blocked. Possible reasons for this are:
The user B, B.1, B.2 mistakenly believes that the escape route Fw is blocked, for example because the user believes a door to be locked, but this door is merely difficult to open.
The user B, B.1, B.2 accidentally entered “Escape route blocked,” for example because the user B, B.1, B.2 is in a panic state.
The user B, B.1, B.2 intentionally entered a false “Escape route blocked” input.

In one implementation, an escape assistance device 100, 100.1, 100.2 indicates a query to its user B, B.1, B.2 as to whether or not the segment is actually blocked. Preferably, this query is only output to a user B, B.1, B.2 if this user B, B.1, B.2 is currently not in a panic state.

In one implementation, the navigation unit 20.l, 20.z only rates an escape route Fw as blocked if there are n user inputs that this escape route is blocked, where n>=2 is a given number.

In one embodiment, the navigation unit 20.l, 20.z causes the information about a blocked segment to be transmitted to all escape assistance devices 100, 100.1, 100.2 in the monitored area Ar or at least to all escape assistance devices in the vicinity of the blocked segment. Preferably, the navigation unit 20.l, 20.z also causes this message to be transmitted to the central rescue center Z. In one embodiment, this message to the escape assistance devices 100, 100.1, 100.2 and to the central rescue center Z comprises an image of the blocked segment, wherein the user B, B.1, B.2 has taken this image with the camera of his/her escape assistance device 100, 100.1, 100.2 as just described.

The following situation is also possible: The navigation unit 20.l, 20.z detects automatically, i.e., without user input, that the calculated escape route Fw is currently impassable. In particular, the navigation unit 20.l, 20.z detects that an alarm situation has occurred at a measuring position on the escape route Fw. It is possible that this alarm situation had not yet occurred when the navigation unit 20.l, 20.z received the alarm message AN and thereupon calculated the escape route Fw. For example, the navigation unit 20.l, 20.z receives and processes a signal of a gas warning device 1.1, 1.2 or a smoke detector 1.3 or a flame detector 1.4. In the exemplary embodiment, the navigation unit 20.l, 20.z receives and processes an alarm situation signal from the alarm unit 10, for example the alarm situation signal AS of FIG. 1. This alarm situation signal AS comprises an identifier of the geoposition of this stationary gas warning device 1.1, 1.2, 1.3, 1.4. The navigation unit 20.l, 20.z detects that the user B, B.1, B.2 has not yet passed this measuring position. The detection that an alarm situation exists at a position that lies on the escape route Fw and that the user B, B.1, B.2 has not yet passed also triggers, in one embodiment, the step of the navigation unit 20.l, 20.z calculating a new escape route.

One embodiment was described above in which a description of the area Ar to be monitored and the respective geoposition and optionally the respective current state of each user B, B.1, B.2 in this area Ar are displayed on the screen 5. In one embodiment, the description of the spatial area Ar additionally indicates which segments are currently blocked and therefore cannot be part of a passable escape route.

It has just been explained that the navigation unit 20.l, 20.z detects, based on a user input or a received and processed signal of a sensor, that the calculated escape route Fw is impassable. In response to this detection, the navigation unit 20.l, 20.z calculates a new escape route starting at the current geoposition Pos.x of the user B, B.1, B.2. The navigation unit 20.l, 20.z marks a segment of the old escape route Fw as impassable for the calculation, more precisely: a segment of a computer-evaluable description of the old escape route Fw. This segment starts at the current geoposition of the user B, B.1, B.2 or more generally at the point of the escape route Fw that is closest to the current geoposition and has, for example, a specified length. This prevents the newly calculated escape route from comprising the segment that has been marked as impassable.

The previous passages of this section have described the situations in which the navigation unit 20.l, 20.z calculates an updated escape route. It is also possible that the navigation unit 20.l, 20.z generates a modified escape route description for an unchanged escape route Fw and causes the output unit 30, 30.1, 30.2 to output the current escape route description. One reason for generating an updated escape route description is that the user B, B.1, B.2 selects a different type of escape route description with the aid of the above-described selection unit on his/her escape assistance device 100. An additional or alternative embodiment is described below.

According to this embodiment, the navigation unit 20.l, 20.z continuously evaluates the signal of the vital parameter sensor 50, 50.1, 50.2 of a user B, B.1, B.2 and decides on the current state of the user B, B.1, B.2. For example, the navigation unit 20.l, 20.z detects that the user B, B.1, B.2 was initially not in a panic state, which is why the navigation unit 20.l, 20.z generated an escape route description that can only be understood by a calm user, for example the escape route description Des.2 of FIG. 4. Later, the navigation unit 20.l, 20.z detects that the user B, B.1, B.2 is now in a panic state. Based on this detection, the navigation unit 20.l, 20.z generates an escape route description that is easier to understand, for example the escape route description Des.1 of FIG. 4 or that of FIG. 5.

The embodiment described below takes into account the situation that the monitored spatial area Ar must be completely evacuated, i.e., that all users B, B.1, B.2 must leave the spatial area Ar. There is the possibility that, in doing so, a traffic jam with a plurality of users will occur. The embodiment reduces the risk of this undesirable event.

This embodiment is described for the case where all users B, B.1, B.2 are to be guided to the same safe target position, here the meeting point Sp. The embodiment is initially described using a central navigation unit 20.z.

As explained above, the central navigation unit 20.z calculates for each user B, B.1, B.2 who has to leave the spatial area Ar a respective escape route Fw. According to one implementation, the navigation unit 20.z calculates for each escape route Fw an estimate of how long the user B, B.1, B.2 needs to reach from his/her current geoposition Pos.s via this escape route Fw the or a safe target position Sp. This estimated time duration depends
on the length of the escape route Fw,
optionally on a permanent or currently occurring bottleneck,
on an impairment of the user B, B.1, B.2 in walking or running, and
on the current state of the user B, B.1, B.2, in particular on whether or not the user B, B.1, B.2 is currently in a panic state.

Through read access to the area data memory 23, the navigation unit 20.z determines which bottlenecks the escape route Fw has. The navigation unit 20.z determines a possible impairment of the user B, B.1, B.2 through read access to the user data memory 22, 22.1, 22.2. The navigation unit 20.z determines the current state of the user B, B.1, B.2 by evaluating the signal of the vital parameter sensor 50, 50.1, 50.2. The navigation unit 20.z actuates the escape assistance devices 100, 100.1, 100.2 and thus the output units 30, 30.1, 30.2 such that they do not display the particular escape route description Des.1, Des.2 simultaneously, but with a time delay. The chronological order in which the escape route descriptions Des.1, Des.2 are output depends on the estimated expected time that this user B, B.1, B.2 needs for the escape route Fw. The escape route description Des.1, Des.2 for the shortest escape route Fw is output first. Optionally, the escape route for a user B.1 in a panic state is output earlier than the escape route for another user B.2.

In certain embodiments, the area data memory 23 stores identifiers of bottlenecks in the spatial area Ar. Preferably, for each bottleneck a respective identifier of the geoposition of the bottleneck is stored. In one embodiment, the navigation unit 20.z counts for each bottleneck how many calculated escape routes lead through this bottleneck. If this number is greater than a given upper limit, the navigation unit 20.z selects a calculated escape route and, for this user, calculates another escape route that does not lead through the bottleneck. Which escape route the navigation unit 20.z selects for this purpose depends primarily on the respective current geoposition of the users B, B.1, B.2.

The possibility was described above that a user B, B.1, B.2 makes a user input that an escape route Fw is impassable. One reason for this user input may be that there are many users in front of a bottleneck. This user input can also be a reason for the navigation unit 20.z to calculate a different escape route for this user.

The previous description refers to a central navigation unit 20.z, which was described above with reference to FIG. 4. With reference to FIG. 3, a local navigation unit 20.l of an escape assistance device 100 was described. If escape assistance devices 100 with local navigation units 20.l are used, these escape assistance devices 100 exchange messages about calculated escape routes with one another. If necessary, a local navigation unit 20.l calculates an updated escape route Fw.x and for this purpose applies the principles just described.

List of reference signs

| | |
|---|---|
| 1.1, 1.2 | Stationary gas warning device, measures the |
| | concentration of at least one target gas in its detection |
| | range Det.1, Det.2 |
| 1.3 | Smoke detector, detects the occurrence of smoke in its |
| | detection range Det.3 |
| 1.4 | Flame detector, detects the occurrence of flames and fire |
| | and optionally of heat in its detection range Det.4 |
| 2 | Acoustic output unit in the form of a loudspeaker, is |
| | actuated by the alarm unit 10, outputs voice messages |
| 3 | Visual display unit, is actuated by the alarm unit 10, |
| | indicates a direction in which one can leave the spatial |
| | area Ar |
| 3.1 | Further visual display unit |
| 5 | Screen in the central rescue center Z |
| 6 | Communication unit of the central navigation unit 20.z |
| 8 | Alarm activation unit in the central rescue center Z, can be |
| | activated by a human, if activated causes an alarm |
| | message AN to be generated |
| 10 | Signal-processing alarm unit in the central rescue center |
| | Z, receives a signal from each stationary gas warning |
| | device 1.1, 1.2 and from the smoke detector 1.3 and the |
| | flame detector 1.4, controls the loudspeaker 2 and the |
| | visual display unit 3, generates a signal for the escape |
| | assistance device 100, 100.1, 100.2 |
| 20.l | Local navigation unit, calculates an escape route Fw for |
| | the user B of the escape assistance device 100, belongs |
| | to the escape assistance device 100 |
| 20.z | Central navigation unit, calculates an escape route Fw for |
| | the users B.1, B.2 and generates a respective escape |
| | route Fw |
| 22 | User data memory, in which information about the user B |
| | is stored |
| 22.1, 22.2 | User data memory, in which information about the user |
| | B.1, B.2 is stored |
| 23 | Area data memory, on which a computer-evaluable map of |
| | the spatial area Ar and a description of safe target |
| | positions are stored |
| 25, | Communication unit of the escape assistance device 100, |
| 25.1, 25.2 | 100.1, 100.2 |
| 30, | Touch-sensitive user interface of the escape assistance |
| 30.1, 30.2 | device 100, 100.1, 100.2, provides the output unit |
| 40, | Geoposition sensor of the escape assistance device 100, |
| 40.1, 40.2 | 100.1, 100.2, measures the current geoposition of the |
| | user B, B.1, B.2 |
| 50, | Vital parameter sensor of the escape assistance device |
| 50.1, 50.2 | 100, 100.1, 100.2, measures vital parameters of the user |
| | B, B.1, B.2 |
| 51 | Humidity sensor, measures the humidity at a measuring |
| | position in the spatial area Ar |
| 52 | Temperature sensor, measures the temperature at a |
| | measuring position in the spatial area Ar |
| 53 | Wind sensor, measures the strength and direction of wind |
| | at a measuring position in the spatial area Ar |
| 100 | Portable escape assistance device, is carried by the user |
| | B, comprises the local navigation unit 20.l, the output unit |
| | 30, the geoposition sensor 40, the vital parameter sensor |
| | 50, and the communication unit 25, is configured in one |
| | implementation as a smartphone or a smart watch |
| 100.1, 100.2 | Portable escape assistance device, is carried by the user |
| | B, comprises the output unit 30.1, 30.2, the geoposition |
| | sensor 40.1, 40.2, the vital parameter sensor 50.1, 50.2 |
| | and the communication unit 25.1, 25.2, is configured in |
| | one implementation as a smartphone, receives a signal |
| | from the central navigation unit 20.z |
| AN | Alarm message, generated by the alarm unit 10 due to a |
| | sensor signal or an activation of the alarm activation unit |
| | 8, comprises information that an alarm situation has |
| | occurred, is transmitted to the navigation unit 20.l, 20.z |
| Ar | Monitored spatial area |
| AS | Alarm situation message, generated by the alarm unit 10 |
| | based on a sensor signal, comprises information about an |
| | alarm situation and information about the geoposition of |
| | the sensor that detected the alarm situation, is transmitted |
| | to the navigation unit 20.l, 20.z |
| B | User of the escape assistance device 100 |
| B.1, B.2 | User of the escape assistance device 100.1, 100.2 |
| Des.1 | Description of the escape route Fw for the user B.1, is |
| | output on the output unit 30.1 |
| Des.1.a, | Images of the escape route description Des.1 |
| Des.1.b, | |
| Des.1.c | |
| Des.2 | Description of the escape route Fw for the user B.2, is |
| | output on the output unit 30.2 |
| Det.1, Det.2 | Spatial detection range of the gas warning device 1.1, 1.2 |
| Det.3 | Spatial detection range of the stationary smoke detector |
| Det.4 | Spatial detection range of the stationary flame detector |
| Fw | escape route, calculated by the navigation unit 20.l, 20.z |
| Fw.x | further escape route, starts at the starting geoposition |
| | Pos.x |
| Pos.1.1 | Geoposition of the gas warning device 1.1 |
| Pos.a, Pos.b | intermediate geopositions |
| Pos.s | starting geoposition |
| Pos.x | starting geoposition of the further escape route Fw.x |
| Sp | Meeting point outside the spatial area Ar |
| T | Door in the area Ar |
| Z | Central rescue center outside the spatial area Ar |

1.-8. (canceled)

9. An escape assistance arrangement comprising:
an escape assistance device; and
a signal-processing navigation unit,
wherein the escape assistance device is configured to be carried by a user,
wherein the escape assistance device comprises:
a vital parameter sensor;
a geoposition sensor; and
an output unit,
wherein the vital parameter sensor is configured to:
measure a vital parameter of the user; and
generate a signal comprising information of the measured vital parameter;
wherein the geoposition sensor is configured to:
measure a current geoposition of the geoposition sensor; and
generate a signal comprising information of the measured current geoposition,
wherein the navigation unit has, at least temporarily, read access to an area data memory, the area data memory comprising:
a given computer-evaluable description of a spatial area; and
a given computer-evaluable identifier of a given safe target position,
wherein the navigation unit is configured to receive an alarm message,
wherein the alarm message comprises information of the presence of an alarm situation in the spatial area,
wherein the navigation unit is further configured to, in response to receiving an alarm message:
calculate an escape route for the user, wherein the escape route begins at the measured current geoposition and leads to the safe target position;
generate an escape route description, wherein the escape route description describes the calculated escape route in a form perceptible by a human; and
actuate the output unit, wherein the output unit is configured to output the generated escape route description in response to the actuation of the output unit,
wherein calculating the escape route comprises using, by the navigation unit:
a signal of the geoposition sensor;
the computer-evaluable description of the spatial area; and
the computer-evaluable identifier of the safe target position,
wherein the navigation unit is configured to generate two different possible escape route descriptions for the calculated escape route; and
wherein the navigation unit is configured to:
classify, depending on the signal of the vital parameter sensor, a current state of the user; and
generate, depending on the classified state of the user, one of the possible escape route descriptions as the escape route description to be output.

10. The escape assistance arrangement of claim 9, wherein:
the vital parameter sensor is configured to measure at least one of:
a heart rate of the user and
a respiratory rate of the user, and
wherein the navigation unit is configured to:
automatically determine, depending on at least one of the measured heart rate and the measured respiratory rate, whether or not the user is currently in a panic state; and
generate the escape route description depending on whether or not the user is currently in a panic state.

11. The escape assistance arrangement of claim 9, wherein:
the given area data memory stores:
an image set comprising a plurality of images; and
for each image of the image set, a respective identifier of a geoposition,
wherein each stored image shows a respective part of the spatial area and wherein the stored respective identifier indicates a geoposition at which the stored image was generated,
wherein the navigation unit is configured to generate the escape route description for the calculated escape route by using the respective geoposition identifiers of the image set in such a way that the escape route description comprises an image sequence with at least one image of the image set;
wherein every image of the image sequence shows a respective part of the spatial area past through which the calculated escape route leads; and
wherein, if the image sequence comprises several images, an order of the images in the image sequence corresponds to an order in which the user moving along the escape route reaches the respective parts of the spatial area depicted in the images.

12. The escape assistance arrangement of claim 9, wherein the navigation unit is configured, subsequent to the actuated output unit outputting the generated escape route description, to:
classify the current state of the user depending on the signal of the vital parameter sensor, thereby generating a renewed classification;
generate, depending on the renewed classification, an updated escape route description; and
cause, by an actuation corresponding to the updated escape route description, the output unit to output the updated escape route description.

13. The escape assistance arrangement of claim 9,
wherein the navigation unit is configured, subsequent to the actuated output unit outputting the escape route description, to:
determine, using the signal of the geoposition sensor, an updated current geoposition of the escape assistance device; and
compare the updated current geoposition with the calculated escape route, and wherein the navigation unit is further configured to:
calculate an updated escape route, wherein the updated escape route starts at the updated current geoposition,
generate the updated escape route description in such a way that the updated escape route description describes the updated escape route, and
cause, by an actuation corresponding to the updated escape route description, the output unit to output the updated escape route description.

14. The escape assistance arrangement of claim 9:
wherein the navigation unit is configured to update the escape route description in response to detecting that the user has deviated from the originally calculated escape route by more than a specified distance.

15. The escape assistance arrangement of claim 9:
wherein the navigation unit outputs a notification message based on detecting that the user has deviated from the calculated escape route.

16. The escape assistance arrangement of claim 9:
wherein the navigation unit is configured to:
process an alarm situation signal comprising a geoposition of an alarm situation; and
calculate the escape route so as to ensure that the escape route is at a sufficiently large distance from the geoposition of the received alarm situation signal.

17. The escape assistance arrangement of claim 9,
wherein the navigation unit is configured to select a presentation type of the escape route description based on whether or not the user is in a panic state.

18. The escape assistance arrangement of claim 9,
wherein the escape route description for a user in a panic state comprises an image sequence associated with a sequence of geopositions along the calculated escape route.

19. An escape assistance method, which method is performed using an escape assistance arrangement,
wherein the escape assistance arrangement comprises:
an escape assistance device, wherein the escape assistance device comprises:
a vital parameter sensor;
a geoposition sensor; and
an output unit; and
a signal-processing navigation unit, wherein the navigation unit has, at least temporarily, read access to an area data memory, the area data memory comprising:
a given computer-evaluable description of a spatial area; and
a given computer-evaluable identifier of a given safe target position, wherein the escape assistance method is performed while a user carries the escape assistance device;
wherein the escape assistance method is triggered by the navigation unit receiving an alarm message;
wherein the received alarm message comprises information indicating a presence of an alarm situation in the spatial area; and
wherein the escape assistance method comprises:
measuring, by the vital parameter sensor, a vital parameter of the user;
generating, by the vital parameter sensor, a signal comprising information about the measured vital parameter;
measuring, by the geoposition sensor, a current geoposition of the geoposition sensor;
generating, by the geoposition sensor, a signal comprising information about the current geoposition of the geoposition sensor;
calculating, by the navigation unit, an escape route for the user, wherein the escape route starts at the current geoposition of the geoposition sensor and leads to the safe target position;
generating, by the navigation unit, an escape route description, wherein the escape route description describes the calculated escape route in a form perceptible by a human;
actuating, by the navigation unit, the output unit; and
outputting, by the actuated output unit, the generated escape route description;
wherein the step of calculating, by the navigation unit, the escape route is performed using:
the signal comprising information about the current geoposition of the geoposition sensor;
the stored description of the spatial area; and
the stored identifier of the safe target position,
wherein the navigation unit classifies a current state of the user depending on the signal comprising information about the measured vital parameter;
wherein the navigation unit is configured to generate two different possible escape route descriptions for the calculated escape route; and
wherein the navigation unit generates, depending on the classified state of the user, the escape route description, the generated escape route description being one of the possible escape route descriptions.

20. The escape assistance method of claim 19, wherein, subsequent to the step of outputting the escape route description, the navigation unit performs the additional steps of:
depending on a second signal comprising information about the measured vital parameter, classifying the current state of the user, thereby generating a renewed classification;
generating, depending on the renewed classification, an updated escape route description; and
generating a corresponding actuation to cause the output unit to output the updated escape route description.

21. The escape assistance method of claim 19,
wherein the step of generating, by the navigation unit, the updated escape route description comprises:
determining an updated current geoposition of the escape assistance device, for which purpose the navigation unit uses the signal comprising information about the current geoposition of the geoposition sensor; and
calculating the updated escape route, wherein the updated escape route starts at the updated current geoposition, and
wherein the navigation unit generates the updated escape route description in such a way that the updated escape route description describes the updated escape route.

22. The escape assistance method of claim 19, further comprising:
automatically determining, depending on at least one of a measured heart rate of the user and a measured respiratory rate of the user, whether or not the user is currently in a panic state, and
wherein the generating the escape route description is based on the determination of whether or not the user is currently in a panic state.

23. The escape assistance method of claim 22, wherein the automatically determining comprises measuring, using the vital parameter sensor, at least one of a heart rate of the user and a respiratory rate of the user to generate at least one of the measured heart rate of the user and the measured respiratory rate of the user.

24. The escape assistance method of claim 19, wherein the given area data memory stores:
an image set comprising a plurality of images; and
for each stored image of the image set, a respective identifier of a geoposition,
wherein each stored image shows a respective part of the spatial area and wherein the stored respective identifier indicates a geoposition at which the stored image was taken.

25. The escape assistance method of claim 24,
wherein the navigation unit generates the escape route description for the calculated escape route by using the respective identifiers of the image set in such a way that the escape route description comprises an image sequence with at least one image of the image set;
wherein every image of the image sequence shows a respective part of the spatial area past through which the calculated escape route leads; and
wherein, if the image sequence comprises several images, an order of the images in the image sequence corresponds to an order in which the user moving along the escape route reaches the respective parts of the spatial area depicted in the images.

26. The escape assistance method of claim 19, further comprising, with the navigation unit and subsequent to the actuated output unit outputting the generated escape route description:
classifying, with a renewed classification, the current state of the user depending on the signal of the vital parameter sensor;
generating, depending on the renewed classification, an updated escape route description; and
causing, by a corresponding actuation, the output unit to output the updated escape route description.

27. The escape assistance method of claim 26,
further comprising, with the navigation unit, subsequent to the actuated output unit outputting the escape route description:
determining an updated current geoposition of the escape assistance device using the signal of the geoposition sensor; and
comparing the updated current geoposition with the calculated escape route.

28. The escape assistance method of claim 26, further comprising, with the navigation unit:
calculating an updated escape route, wherein the updated escape route starts at the updated current geoposition, and
generating the updated escape route description in such a way that the updated escape route description describes the updated escape route.
